(19) United States
(12) Patent Application Publication
(10) Pub. No.: US 2010/0084319 A1
(43) Pub. Date: Apr. 8, 2010

(54) Support Chain with Wear Protection for a Support Device for Separating Substances Having Different Flowabilities

(76) Inventors: Oliver Hahn, Parkville, MO (US); Frank Gransee, Parkville, MO (US); Ron Avey, Gladstone, MO (US)

Correspondence Address: VENABLE LLP, P.O. BOX 34385, WASHINGTON, DC, 20043-9998, US

(21) Appl. No.: 12/532,704

(22) PCT Filed: Mar. 15, 2008
(86) PCT No.: PCT/EP08/02418

§ 371 Date: Sep. 23, 2009

(30) Foreign Application Priority Data
Mar. 23, 2007 (DE) 20 2007 004 473.9

(51) Int. Cl. F16G 13/04; B07B 13/00

(52) U.S. Cl. 209/45; 474/214

(57) ABSTRACT

A support chain for a device for supporting a compression belt in a separation device for separating substances having different flowability. The support chain includes an articulated chain having individual chain links that form a flat surface. The links include chain pins with chain plates threaded thereon. A locking device is attached to opposite ends of the chain pins to hold the chain plates together on the chain pins. End pieces are adapted to receive the locking device so that the support chain is planar on both sides facing transversely to the direction of conveying of the support chain. Each end piece connects adjacent chain pins to each other and includes a sliding element and compensating elements. The sliding element has recesses which each include a through-bore and a non-through bore for receiving a respective compensating element. Each recess is constructed to receive the compensating element and locking device therein.

### CROSS-REFERENCE TO RELATED APPLICATION

This application is a National Stage application of PCT/EP2008/002418 filed Mar. 15, 2008, which claims priority to German Application No. 20 2007 004 473.9 filed Apr. 7, 2008.

### BACKGROUND OF THE INVENTION

The invention concerns a support chain for a support device for supporting a compression belt in a separation device for separating substances having different flowability, the support chain being an articulated steel chain and comprising individual chain links connected to each other and forming a substantially flat surface, wherein the chain links are composed of chain pins directed transversely to the direction of conveying F and have a plurality of chain plates threaded thereon, and the chain plates connecting two chain pins each together are held on the chain pins by locking means which are attached to opposite free ends of the chain pins.

Furthermore, the invention concerns a support device for supporting a compression belt in a separation device for separating substances having different flowability, the separation device comprising a housing with side walls, a rotationally driven hollow drum with perforated shell, an endless compression belt that can be pressed against the latter from the outside, wrapping round part of the circumference of the hollow drum, a product feeder nip, stripping means for stripping the compressed material off the hollow drum, the endless compression belt being mounted by means of at least two rollers, one of which can be pressed elastically against the hollow drum, separated by the compression belt, the support device comprising a support element designed as a support chain.

The invention also concerns a separation device for separating substances having different flowability, comprising a housing with side walls, a rotationally driven hollow drum with perforated shell, an endless compression belt that can be pressed against the latter from the outside, wrapping round part of the circumference of the hollow drum, a product feeder nip, stripping means for stripping the compressed material off the hollow drum, the endless compression belt being mounted by means of at least two rollers one of which can be pressed elastically against the hollow drum, separated by the compression belt, and a support device for the compression belt.

Separation devices of this kind, which are also called separators and are described for example in DE-A-20 32 774, in general consist of hollow drums with perforated shells against which the material to be compressed or separated is pressed from the outside by means of an endless compression belt made of an elastic material such as rubber or polyurethane or the like and as a result can exert sufficient pressure on the material to be compressed. Under this pressure, the more readily flowing constituents of the material to be compressed are pressed through the perforations of the shell into the hollow interior of the rotating hollow drum, while the less readily flowing constituents of the material to be compressed remain on the shell of the hollow drum, from where they are stripped by means of stripper means.

Capable of such separation are materials which are distinguished by their flow behaviour that differs from each other. These are to be found for example in the recovery of animal bodies (for example, separation of the meat from skin, sinews, meshes, bones), fruit and vegetables (for example, separation of the fruit pulp from peel, stems, cores or stones), the reprocessing of faultily packed foodstuffs (for example, the separation of butter or cheese from packaging material) or the like.

Due to the resistance of the material to be separated, the elasticity of the compression belt, and due to defective guiding thereof, so-called “pockets of product” frequently form in the region between hollow drum and compression belt, usually in the region between the product feeder nip and the roller that can be pressed elastically against the hollow drum, separated by the compression belt. Due to these pockets of product, the compression belt is subjected to high stress as a result of local expansion, as a result of which its stability decreases greatly in time, as the compression belt wears out. In general this results in damage to the compression belt, which in turn necessitates frequent changes of the compression belt.

The formation of pockets of product is prevented by using a support device which presses the compression belt against the shell of the hollow drum in a partial region of wrapping round the hollow drum. This causes the compression belt to be guided particularly in the region in front of the pressure roller, and so reduces the occurrence of pockets of product.

A separation device comprising a support device of this kind is known for example from WO 00/35292. This support device is an additional belt which, due to the belt pressing against the compression belt in the region between the product feeder nip and the roller that can be pressed elastically against the hollow drum, separated by the compression belt, prevents the compression belt from slipping sideways due to large product pieces or the accumulation of several product pieces, and in this way contributes to preventing the occurrence of pockets of product. Here, however, disadvantages arise, making it difficult to use this support device in practice. Thus support belts likewise have a certain elasticity, on account of which the formation of pockets of product cannot be completely prevented when using support elements of this kind. Furthermore, it is disadvantageous that the belts wear greatly due to the high mechanical load when pressed against the revolving compression belt, so that it is necessary from time to time to replace the worn belts with new belts.

Further developments which are described e.g. in German utility model 20 2004 014 365.8 provide a support chain as the support device or support element. With the support chain, which has a high capacity for mechanical loading, permanent and complete support of the compression belt can be achieved. However, the material to be separated is frequently highly capable of resistance. This capacity for resistance on the one hand and eccentric delivery of the material to be compressed to the feeder nip on the other hand lead to the support chain slipping sideways. At the same time there is frequently contact with the side walls, housing walls or the like of the separation device which receives the support chain. As both the side walls, housing walls or the like and the support chain are made of steel, there is wear at certain points, which requires exchange of the support chain and/or the side walls, housing walls or the like. This wear effect occurs particularly when using the previously used support chains, due to the fact that the chain pins are riveted or fixed by welding at their free ends in the region of a chain plate located on the outside. In other words, the locking means is a rivet head or welding spot which prevents the chain plates from slipping off the chain pins. Due to the projecting welding remains or rivet heads, the support chain is uneven on the sides directed towards the side walls, housing walls or the like. As a result, considerable wear arises at the points of contact of steel on steel, which requires regular exchange of parts of the support chain or even the whole support chain.

### SUMMARY

It is therefore an object of the present invention to provide a low-wear and resilient support chain capable of withstanding high separation pressures. It is further the object of the invention to propose a corresponding support device and a corresponding separation device.

This object is achieved by a support chain of the kind mentioned hereinbefore, by the fact that at the opposite free ends of the chain pins are arranged end pieces which are constructed and designed to receive the locking means in such a way that the support chain is planar on both sides facing transversely to the direction of conveying F of the support chain. This creates a flat sliding and/or friction surface which on the one hand assists guiding of the support chain between the side walls of the separation device and on the other hand reduces the wear on the support chain and/or side walls.

An appropriate development provides that each end piece connects two adjacent chain pins to each other and is composed of at least one sliding element and two compensating elements, the sliding element having recesses which are designed to completely receive the compensating elements and fastening means. This embodiment firstly ensures that the compensating elements and fastening means are completely countersunk within the sliding element, so that no obtrusive sections protrude beyond the flat outer surface of the sliding element. Secondly, the compensating elements prevent tilting/twisting of the chain links, which also causes an increase in the service life of the support chain.

Advantageously, the sliding element is hardened at least at the outwardly facing surface, which further increases the wear resistance.

The object is also achieved by a support device of the kind mentioned hereinbefore by the fact that the support chain is designed according to any of claims 1 to 11. The resulting advantages have already been described in connection with the support chain according to the invention. To avoid repetition, reference is made to the corresponding statements.

The object is also achieved by a separation device having the characteristics mentioned hereinbefore, which is distinguished by the fact that the support device is designed according to claim 12. With respect to the resulting advantages, again reference is made to the corresponding passages on the support chain.

### BRIEF DESCRIPTION OF THE DRAWINGS

The present invention will be more readily understood from the following detailed description when read in conjunction with the accompanying drawings, in which:

FIG. 1 is a schematic view of a separation device having a support chain as part of a support device in a side view;

FIG. 2 is a perspective view of a support chain section with a chain link in an exploded view;

FIG. 3 is a top view of a section of the support chain (shown only partly);

FIG. 4 is a front view of a detail of the separation device with compression belt and support chain arranged between side walls;

FIG. 5 is a top view of the sliding element;

FIG. 6 is a side view of the sliding element;

FIG. 7 is a top view of the compensating element; and

FIG. 8 is a side view of the compensating element.

### DETAILED DESCRIPTION

The support chain shown serves to support a compression belt in a separation device for separating substances having different flowability. Naturally, the support chain can also be used in other areas and for other purposes.

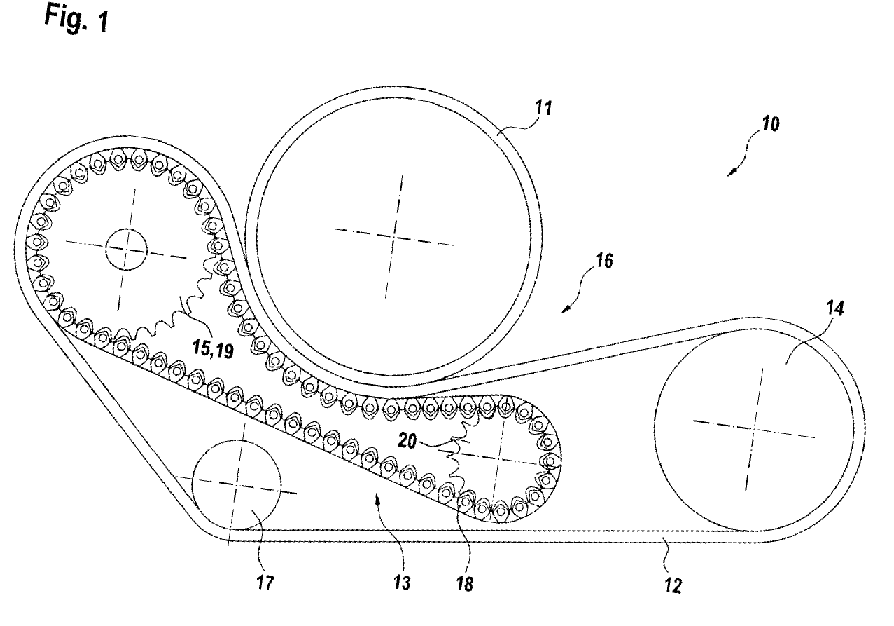

For a better understanding of the invention, first a separation device 10 is described with the aid of FIG. 1, in which the support chain according to the invention, which is described in detail below, is preferably used. The separation device 10 shown comprises a rotatably driven hollow drum 11 which has a shell with perforations. The hollow drum 11 mounted rotatably in a frame (not shown in FIG. 1; guiding side walls in FIG. 1 standing parallel to the plane of the drawing in FIG. 1 not shown (in FIG. 4 side walls 22, 23)) is wrapped over part of its circumference by an endless squeezing belt 12 (also termed compression belt in the following) which is made of an elastic material such as for example rubber, polyurethane or the like, either in the form of a one-piece web or braided. For the purpose of avoiding pockets of product in the region of wrap, a support device 13 is provided for support of the compression belt 12.

The compression belt 12 is guided over bearing rollers 14, 15, of which roller 15 is designed as the driven pressure roller by means of which the compression belt 12 can be pressed against the hollow drum 11. Roller 14 is constructed as a tensioning roller and arranged in such a way that the compression belt 12 with the hollow drum 11 forms a product feeder nip 16. A guide roller 17 serves as a deflecting roller and spacer for keeping the returning sections of the compression belt 12 and support device 13 apart from each other. In the upper region of the periphery of the hollow drum 11 are located stripping means (not shown) comprising a stripping blade which cooperates with the outer shell of the hollow drum 11.

The support device 13 or support element is here designed as a support chain 18 which is held by bearing rollers 19, 20, roller 19 being constructed as a drive roller and roller 20 being a tensioning roller by means of which the pressure which the support chain 18 exerts on the compression belt 12 can be adjusted. It is particularly favourable here if roller 20 cooperates with roller 19 in such a way that the pressure of the support chain 18 against the compression belt 12 is readjusted by movement of roller 20, for example using a hydraulic system or one or more springs. As a result it is possible that, as soon as for example roller 20 is pushed away from the hollow drum 11 due to the mechanical resistance of the material being compressed, roller 19 is moved up in a movement directed towards the hollow drum 11, so that the pressure of the support chain 18 on the compression belt 12 in general remains constant. The roller 15 in this embodiment serves as a drive roller for both the compression belt 12 and the support chain 18 and is therefore identical with roller 19. A dual function of this kind is obtained by the fact that the roller 15 or 19 is designed as a spur-toothed spur gear or, to be more precise, as a toothed roller of which the teeth mesh with the support chain 18 in form-locking relationship. Hence an efficient drive is provided for the revolving movement of the support chain 18. Synchronous rotation of the compression belt 12 and support chain 18 within the region of wrap is obtained by the fact that the compression belt 12 at the roller 15, 19 lies snugly against the outwardly facing side of the support chain 18, so that the compression belt 12 and the support chain 18 are driven at the same speed of rotation due to static friction alone, and therefore rotate at the same speed in the region of wrap.

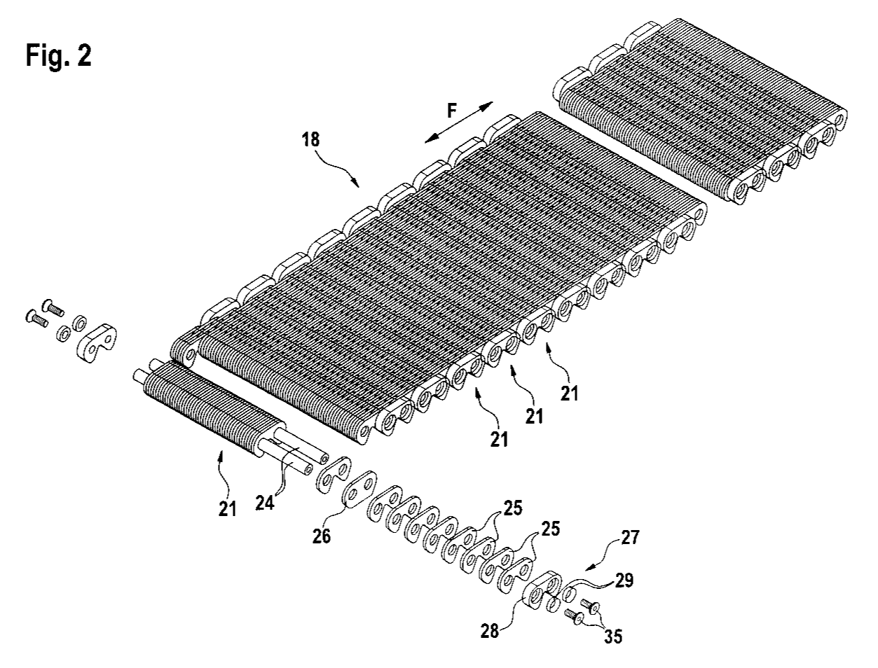

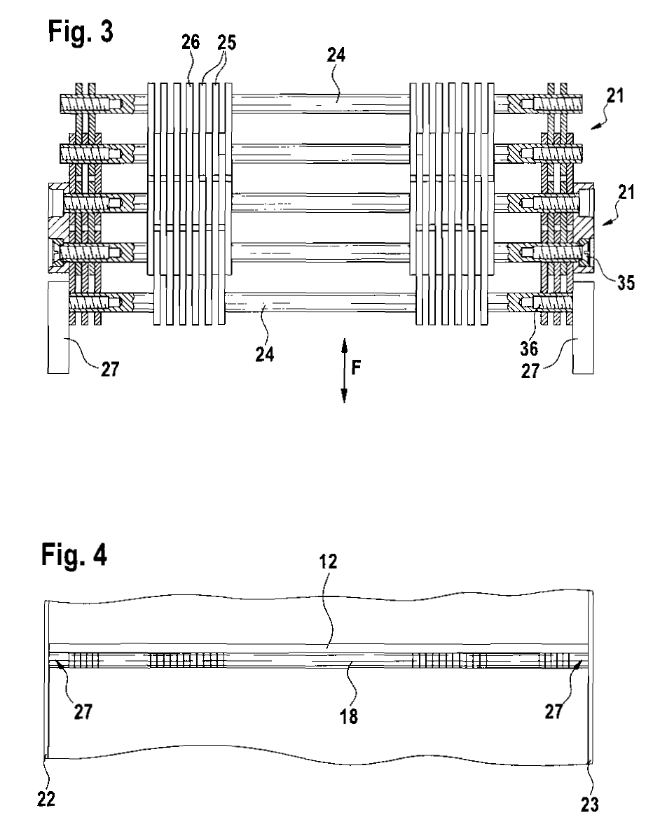

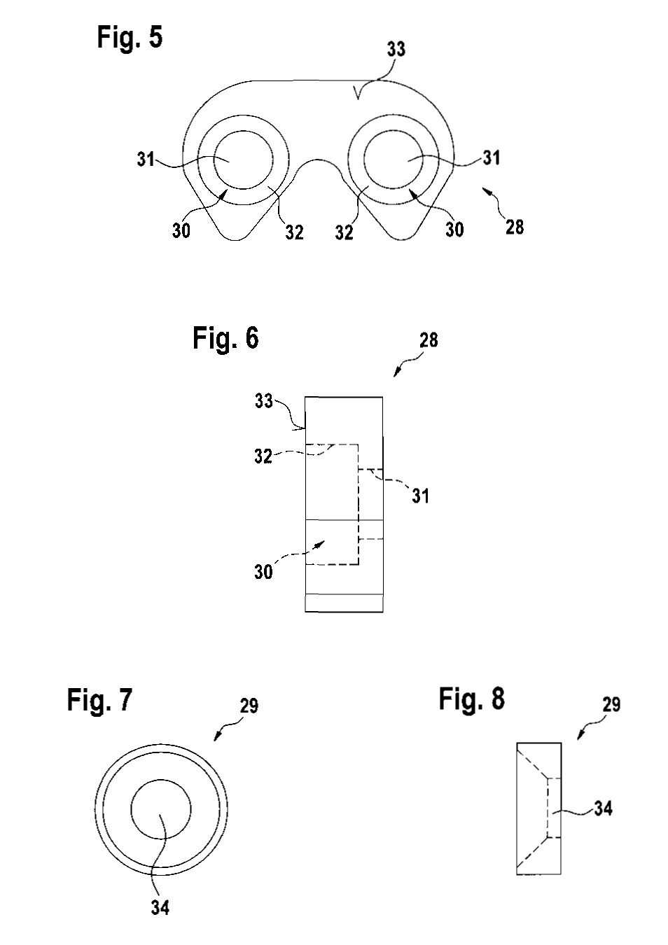

The support chain 18, which is shown in details in FIG. 2, is constructed as an articulated steel chain, preferably made of chrome-nickel (Cr—Ni), and consists of a plurality of articulately connected chain links 21, a chain link 21 being shown schematically and by way of example in an exploded view in FIG. 2. Many adjacent chain links 21 form a substantially flat surface. “Flat” here does not necessarily mean completely closed. “Flat” also includes a surface which, due to the interlaced arrangement of the chain links 21, has smaller gaps. In any case the surface of the support chain 18 is suitable for planar contact with the compression belt 12 (see also FIG. 4).

The chain links 21 are composed of chain link pins 24 running transversely to the direction of conveying F, with a plurality of chain plates 25 arranged or threaded thereon. The chain pins 24 are preferably made of a resilient and hardenable Cr—Ni steel. The chain plates 25 are also made of a Cr—Ni steel hardened at least at the surfaces or hardened all the way through. In this case the chain plates 25 are arranged in interlaced fashion on the chain pins 24 in such a way that a connection is made with the adjacent chain links 21. Each chain link 21 has at least one, preferably two guide plates 26 which are threaded on the chain pins 24 in the same way as the chain plates 25. The guide plates 26 are also made of a resilient and hardenable Cr—Ni steel. At the opposite free ends of the chain pins 24 are arranged locking means which are described in more detail below and which prevent the chain plates 25 and guide plates 26 from slipping off the chain pins 24. In other words, the locking means are attached to the chain pins 24 in order to keep the chain plates 25 and the guide plates 26 on the chain pins 24.

Furthermore, end pieces 27 are associated with the free ends of the chain pins 24. These end pieces 27, which preferably connect two adjacent chain pins 24 of a chain link 21 to each other, are constructed and arranged for receiving the locking means in such a way that the support chain 18 is planar on both sides facing transversely to the direction of conveying F of the support chain 18. The end pieces 27 form a planar closure of the support chain 18 facing towards the side walls 22, 23, this being independently of the design of the locking means.

In the embodiment described, each end piece 27 is composed of one sliding element 28 and two compensating elements 29. But the compensating elements 29 can optionally be dispensed with. The sliding element 28 has recesses 30 which are designed for completely receiving the compensating elements 29 as well as the locking means. Each sliding element 28 has two recesses 30. The recesses 30 are firstly formed by a through-bore 31 and secondly by a non-through-bore 32, the diameter of bore 32 being larger than the diameter of the through-bore 31. Naturally the recesses 30 can have any other ordinary shape and design. Also the sliding element 28 can have more than two of these recesses 30.

The sliding element 28 is preferably made of Cr—Ni steel, the sliding element 28 being hardened at least on the outwardly facing surface 33. The sliding element 28 may also be hardened all the way through, and is smooth and flat on the outwardly facing surface 33. Alternatively, the sliding element 28 may also be provided with a plastic coating on the outwardly facing side. Constructing the sliding element 28 completely from plastic is possible too. Even combinations of the above embodiments are possible.

The compensating elements 29 associated or to be associated with the sliding element 28 each have a through-bore 34 for receiving the locking means. The through-bore 34 is designed for a countersunk head and therefore widens outwardly. The compensating element 29 is usually made of Cr—Ni steel. Other materials as well as designs and embodiments of the compensating element 29 are possible too.

Preferably a screw 35 is used as the locking means. The screw 35, which is designed as a countersunk-head screw, is releasably attached to a chain pin 24, the screw 35 being passed through the through-bore 34 of the compensating element 29. The screw 35 corresponds to a thread 36 formed in the chain pins 24. For this purpose the chain pin 24 extends through the through-bore 31 or lies in it. The compensating element 29 has an outside diameter which is slightly smaller than the inside diameter of the bore 32, so that compensating movements within the recess 30 are possible.

Alternatively to the screw connection described, which allows easy exchange of the end pieces 27 or parts thereof, the locking means can also be a rivet head, a blind rivet or a welded joint. In the case of all connections, only the compensating element 29 is directly attached to the chain pins 24. The sliding element 28 is, due to the slightly larger diameter of the through-bore 31 compared with the diameter of the chain pins 24, able to compensate for tilting of the support chain 18, in order always to guarantee contact of the sliding elements 28 with the side walls 22, 23 over the whole surface. The end pieces 27 have first and foremost a guiding and protecting function for forming a smooth and planar outer surface of the support chain 18.

The support chain 18 is in the present case a steel articulated chain which is slightly narrower than the width of the compression belt 12, so that it supports the compression belt 12 nearly over its whole width (see in particular FIG. 4). The compression belt 12 itself preferably has a width which corresponds at least to the distance between the side walls 22, 23, so that it fits closely against the side walls 22, 23. As a result the product space is, as it were, sealed off. The distance from the support chain 18 to the side walls 22, 23 is, however, small in order on the one hand to support the compression belt 12 to the maximum and on the other hand to prevent the support chain 18 from slipping sideways.

The support chain 18 can of course be made from different materials, for example polymers, metals/alloys or the like. The choice of material is determined by the required overall stability of the support chain 18, which in turn depends on the intended pressure of the compression belt 12 against the hollow drum 11. This pressure is determined inter alia according to the nature and capacity of the material to be separated for resistance and the speed of rotation of the compression belt 12.

It will be understood that the above description of the present invention is susceptible to various modifications, changes and adaptations, and the same are intended to be comprehended within the meaning and range of equivalents of the appended claims.

1-13. (canceled)

14. A support chain for a support device for supporting a compression belt in a separation device for separating substances having different flowability, the support chain comprising:
an articulated chain comprising individual chain links connected to each other and forming a substantially flat surface, wherein the chain links comprise chain pins directed transversely to a direction of conveying of the support chain, a plurality of chain plates threaded on the chain pins, a locking device attached to opposite free ends of the chain pins to hold the chain plates together on the chain pins, and end pieces constructed and designed to receive the locking device so that the support chain is planar on both sides facing transversely to the direction of conveying of the support chain, wherein each end piece connects two adjacent chain pins to each other and comprises at least one sliding element and two compensating elements, wherein the sliding element has two recesses each of which comprises a through-bore for receiving a respective chain pin and a non-through bore for receiving a respective compensating element, wherein each recess is constructed to completely receive the compensating element and locking device received therein.

15. The support chain according to claim 14, wherein a diameter of each recess is larger than an outside diameter of the respective chain pin.

16. The support chain according to claim 14, wherein the at least one sliding element is smooth and flat on an outward facing side.

17. The support chain according to claim 14, wherein the at least one sliding element is hardened at least on an outwardly facing side.

18. The support chain according to claim 14, wherein the at least one sliding element is coated with plastic at least on an outwardly facing side or the at least one sliding element comprises plastic.

19. The support chain of claim 14, wherein each compensating element defines a bore that receives the locking device.

20. The support chain of claim 14, wherein each locking device comprises a screw assembly releasably attached to each chain pin.

21. The support chain of claim 14, wherein each locking device comprises a rivet head formed from each chain pin.

22. The support chain of claim 14, wherein each locking device comprises a weld joint to each chain pin.

23. A support device for supporting a compressible belt in a separation device for separating substances having different flowability, wherein the separation device includes: a housing with side walls; a rotationally driven hollow drum with a perforated shell: an endless compression belt wrapped around a portion of a circumference of the hollow drum to define a product feeder nip between the endless compression belt and the hollow drum, the compression belt being pressable against the hollow drum from an outside to compress a material; a stripping device arranged to strip compressed material off the hollow drum; at least two rollers to mount the compression belt, wherein one of the rollers is elastically pressable against the hollow drum, separated by the compression belt;
wherein the support device comprises a support chain to support the compression belt, the support device being constructed according to claim 14.

24. The support chain according to claim 14, wherein the articulated chain is comprised of steel.

25. A separation device for separating substances having different flowability, comprising:
a housing with side walls;
a rotationally driven hollow drum with a perforated shell,
an endless compression belt wrapped around a portion of a circumference of the hollow drum to define a product feeder nip between the endless compression belt and hollow drum, the compression belt being pressable against the hollow drum from an outside to compress a material,
a stripping device arranged to strip compressed material off the hollow drum,
at least two rollers to mount the compression belt, wherein one of the rollers is elastically pressable against the hollow drum, separated by the compression belt; and
the support device according to claim 14 arranged to support the compression belt.

26. A method for supporting a compressible belt in a separation device for separating substances having different flowability, wherein the separation device includes: a housing with side walls; a rotationally driven hollow drum with a perforated shell: an endless compression belt wrapped around a portion of a circumference of the hollow drum to define a product feeder nip between the endless compression belt and the hollow drum, the compression belt being pressable against the hollow drum from an outside to compress a material; a stripping device arranged to strip compressed material off the hollow drum; at least two rollers to mount the compression belt, wherein one of the rollers is elastically pressable against the hollow drum; separated by the compression belt,
the method comprising utilizing the support device according to claim 14 to support the compression belt.
